(19) United States
(12) Patent Application Publication
(10) Pub. No.: US 2026/0098373 A1
(43) Pub. Date: Apr. 9, 2026

(54) PARTICULATE FILTRATION SYSTEM FOR AN APPLIANCE

(71) Applicant: WHIRLPOOL CORPORATION, BENTON HARBOR, MI (US)

(72) Inventors: Erika Jimena Cruz Sepulveda, St. Joseph, MI (US); German Cruz Navarro, Floridablanca (CO)

(73) Assignee: WHIRLPOOL CORPORATION, BENTON HARBOR, MI (US)

(21) Appl. No.: 18/908,145

(22) Filed: Oct. 7, 2024

(51) Int. Cl. D06F 39/10; C02F 1/38; C02F 103/00

(52) U.S. Cl. CPC D06F 39/10; C02F 1/38; C02F 2103/002

(57) ABSTRACT

A particulate filtration system for an appliance includes a receiver having inlet and outlet portions. The inlet portion receives effluent from a wastewater conduit and combines the effluent and a coagulant from a coagulant reservoir to define a mixed solution. The system includes a rotor that receives the mixed solution from the receiver and rotates about a rotational axis to generate a centrifugal force to separate the mixed solution into coagulated particles and filtered fluid. The centrifugal force biases the coagulated particles from an interior of the rotor and upward along an angled perimeter wall of the rotor. The filtered fluid is delivered to a drain outlet via the outlet portion of the receiver. The system includes a collection basin that surrounds the rotor which rotates within a central area of the collection basin. The collection basin receives the coagulated particles from the angled perimeter wall of the rotor.

### BACKGROUND OF THE DISCLOSURE

The present disclosure generally relates to filtration systems, and more specifically, a filtration system for an appliance that includes a diffuser that combines a coagulant with greywater to coagulate certain particulate within the greywater for removal from the appliance and separately delivers filtered fluid to an outlet, and wherein the separation of the coagulated particular from the filtered fluid is at least partially performed using centrifugal force.

### SUMMARY OF THE DISCLOSURE

According to one aspect of the present disclosure, a particulate filtration system for an appliance includes: a receiver having an inlet portion and an outlet portion, wherein the inlet portion is configured to receive effluent from a wastewater conduit, and wherein the inlet portion at least partially combines the effluent and a coagulant from a coagulant reservoir to define a mixed solution; a rotor that receives the mixed solution from the receiver and rotates about a rotational axis to generate a centrifugal force to separate the mixed solution into coagulated particles and filtered fluid, wherein the centrifugal force biases the coagulated particles from an interior of the rotor and upward along an angled perimeter wall of the rotor, and wherein the filtered fluid is delivered to a drain outlet via the outlet portion of the receiver; and a collection basin that surrounds the rotor, wherein the rotor rotates within a central area of the collection basin, and wherein the collection basin receives the coagulated particles from the angled perimeter wall of the rotor.

According to another aspect of the present disclosure, a particulate filtration system for an appliance pedestal includes: a receiver that receives effluent, wherein the receiver includes a diffuser that combines a coagulant with the effluent to at least partially define a mixed solution; a distribution shaft that receives the mixed solution from the receiver, the distribution shaft having an internal air pathway and a fluid outlet; a rotor that rotates about a rotational axis to produce a centrifugal force, wherein the rotor receives the mixed solution from an effluent pathway of the distribution shaft, the rotor including a separating chamber that separates the mixed solution using the centrifugal force into a filtered fluid and coagulated particles, wherein the filtered fluid is delivered away from the rotor via the fluid outlet; a processing cap that receives the coagulated particles from an angled perimeter wall of the rotor and delivers the coagulated particles from the rotor and to an upper surface of the processing cap; and an air pump that delivers a delivery airstream through the internal air pathway of the distribution shaft and into the processing cap, wherein the delivery airstream at least partially moves the coagulated particles through drying channels of the processing cap and to the upper surface, and wherein the centrifugal force biases the coagulated particles from the upper surface of the processing cap to a collection basin that surrounds the rotor.

According to yet another aspect of the present disclosure, a particulate filtration system for an appliance includes: a receiver having a Venturi section that receives and combines a effluent with a coagulant from a coagulant reservoir to define a mixed solution; a distribution shaft that receives the mixed solution from the Venturi section, the distribution shaft having an effluent pathway, an internal air pathway, and a fluid outlet; a rotor that rotates about a rotational axis to produce a centrifugal force, wherein the rotor includes a separating chamber that receives the mixed solution from the effluent pathway, and wherein the rotor separates the mixed solution, using the centrifugal force, into a filtered fluid and coagulated particles, the coagulated particles being biased by the centrifugal force upward along an angled perimeter wall of the separating chamber, and wherein the filtered fluid is directed into the fluid outlet of the distribution shaft; processing cap that receives the coagulated particles from the angled perimeter wall and delivers the coagulated particles from the rotor and to an upper surface of the processing cap; and an air pump that delivers a delivery airstream through the internal air pathway of the distribution shaft and into the processing cap, wherein the delivery airstream at least partially moves the coagulated particles through drying channels of the processing cap and to the upper surface, the drying channels extending inward from proximate the angled perimeter wall to proximate the distribution shaft, and wherein the centrifugal force biases the coagulated particles from the upper surface of the processing cap to a collection basin that surrounds the rotor.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a front elevation view of an appliance that incorporates an aspect of a filtration system;

FIG. 2 is a schematic perspective view of an aspect of the filtration system incorporated within a pedestal for an appliance;

FIG. 3 is a schematic perspective view of an aspect of the filtration system and schematically showing locations of an air pump and coagulant reservoir;

FIG. 4 is a cross-sectional view of the filtration system of FIG. 2 taken along line IV-IV;

FIG. 5 is a cross-sectional view of the filtration system of FIG. 2 taken along line V-V;

FIG. 6 is an exploded perspective view of the filtration system of FIG. 3 with the air pump and coagulant reservoir not shown;

FIG. 7 is a perspective view of an aspect of the filtration system with the collection basin removed;

FIG. 8 is a cross-sectional view of the filtration system of FIG. 7 taken along line VIII-VIII;

FIG. 9 is a cross-sectional view of the filtration system of FIG. 7 taken along line IX-IX;

FIG. 10 is a cross-sectional view of an aspect of the processing cap of the rotor of FIG. 7 taken along line X-X;

FIG. 11 is a perspective view of an aspect of the rotor for the filtration system;

FIG. 12 is a bottom perspective view of the rotor of FIG. 11;

FIG. 13 is a cross-sectional view of the rotor of FIG. 7 taken along line XIII-XIII;

FIG. 14 is an enlarged schematic cross-sectional view of the rotor of FIG. 13, taken at area XIV and showing movement of materials through the processing cap;

FIG. 15 is a cross-sectional view of the rotor of FIG. 7 taken along line XV-XV;

FIG. 16 is an enlarged cross-sectional view of the rotor of FIG. 15, taken at area XVI and showing movement of materials through the processing cap;

FIG. 17 is a perspective view of an aspect of the distribution shaft for the filtration system;

FIG. 18 is a schematic cross-sectional view of an aspect of the receiver for the filtration system and showing movement of materials through the Venturi section and diffuser for the receiver;

FIG. 19 is a schematic cross-sectional view of the output portion of the receiver for the filtration system and showing movement of materials through the distribution shaft;

FIG. 20 is a schematic cross-sectional view of the distribution shaft of the receiver for the filtration system and showing movement of materials through the distribution shaft of the receiver; and

FIG. 21 is a schematic cross-sectional view of an aspect of the filtration system and showing movement of materials from the receiver, through the rotor, and into the collection basin.

The components in the figures are not necessarily to scale, emphasis instead being placed upon illustrating the principles described herein.

### DETAILED DESCRIPTION

The present illustrated embodiments reside primarily in combinations of method steps and apparatus components related to a particulate filtration system for an appliance. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

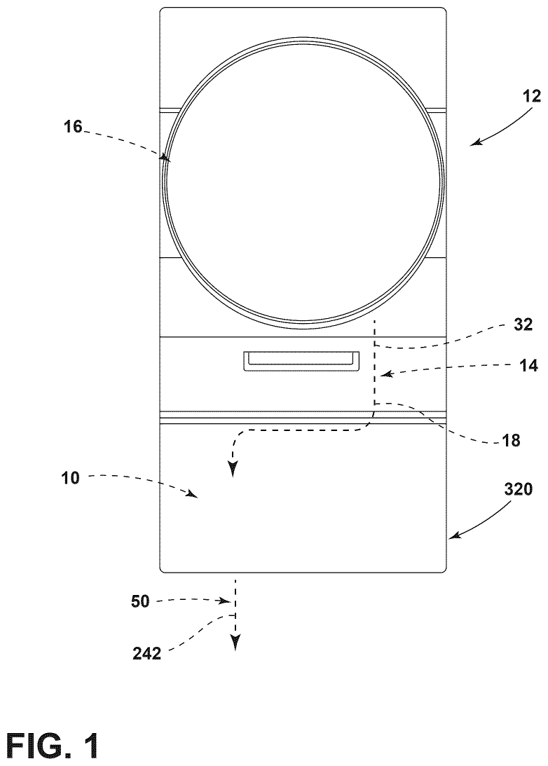

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

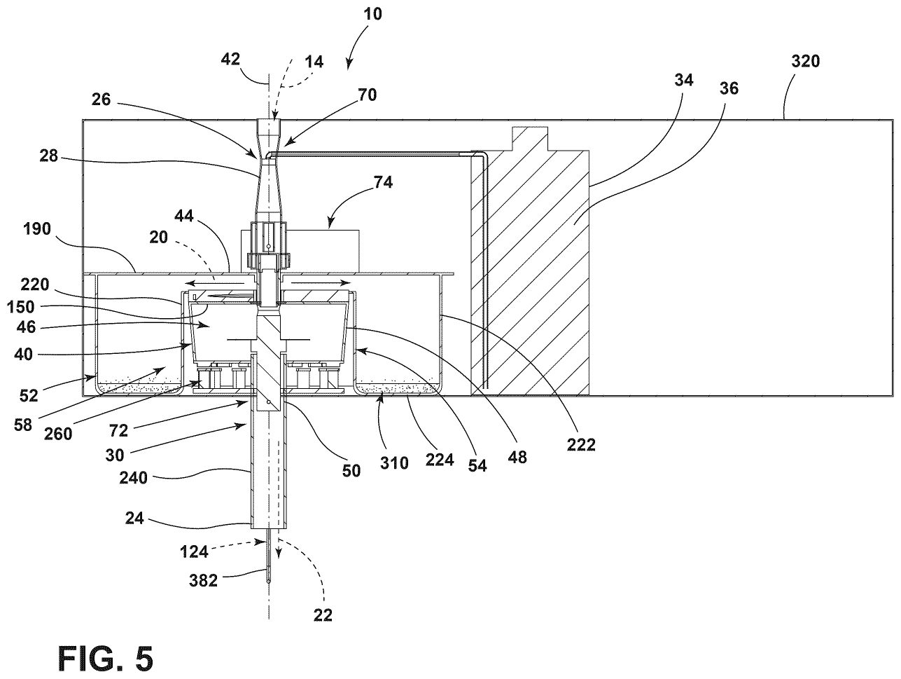

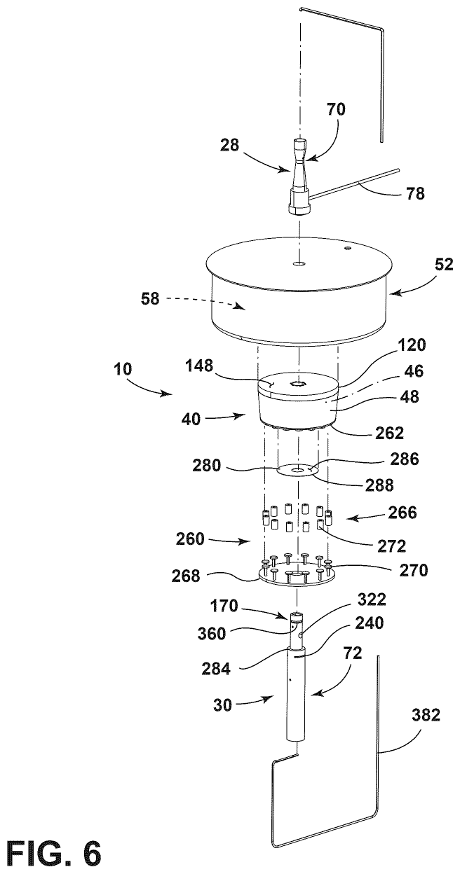

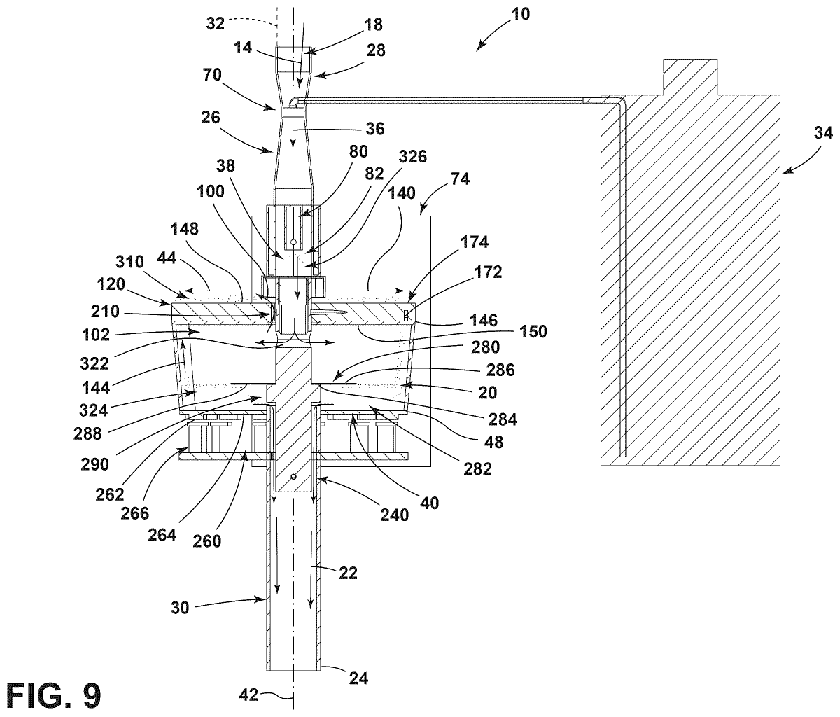

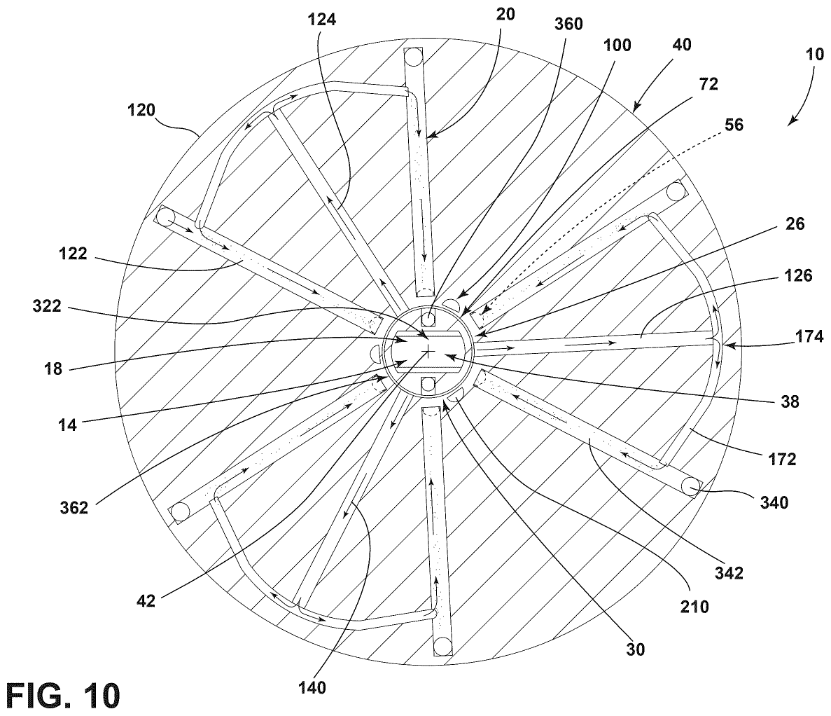

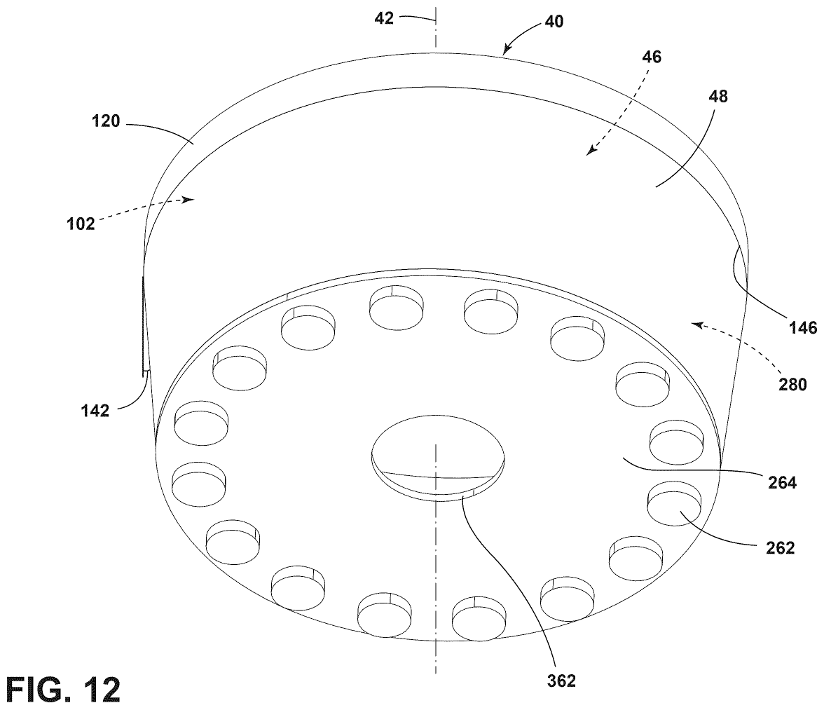

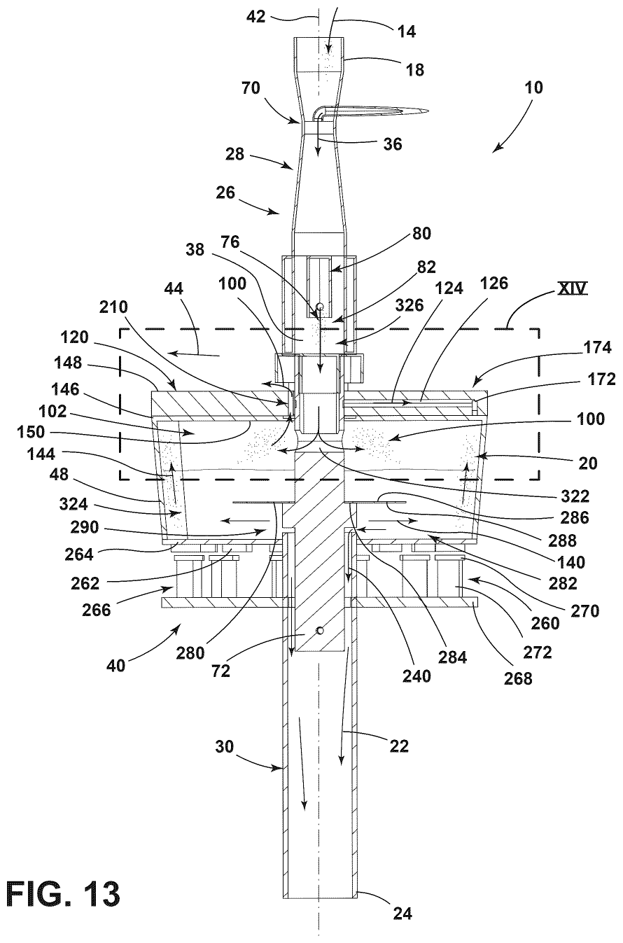

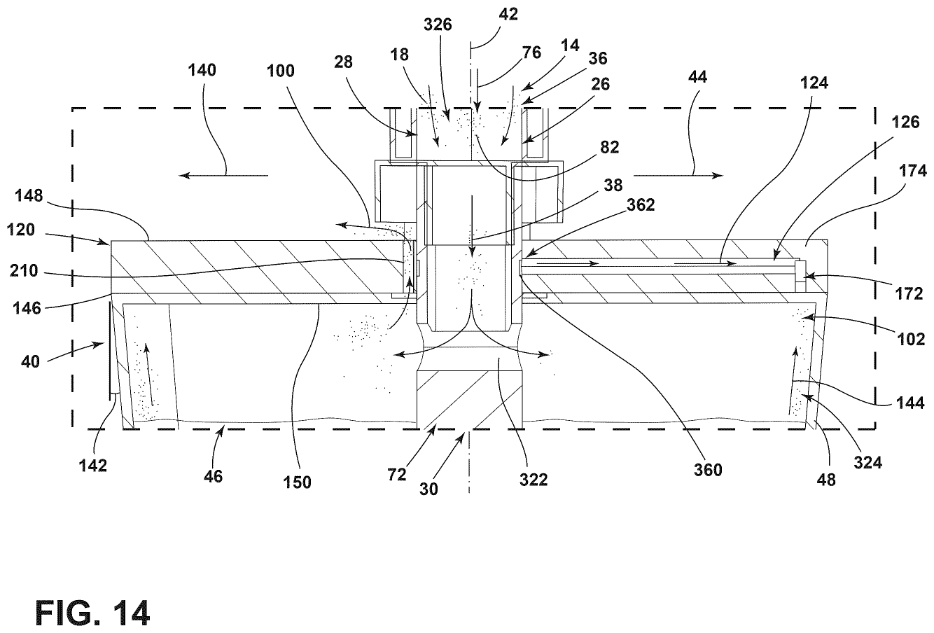

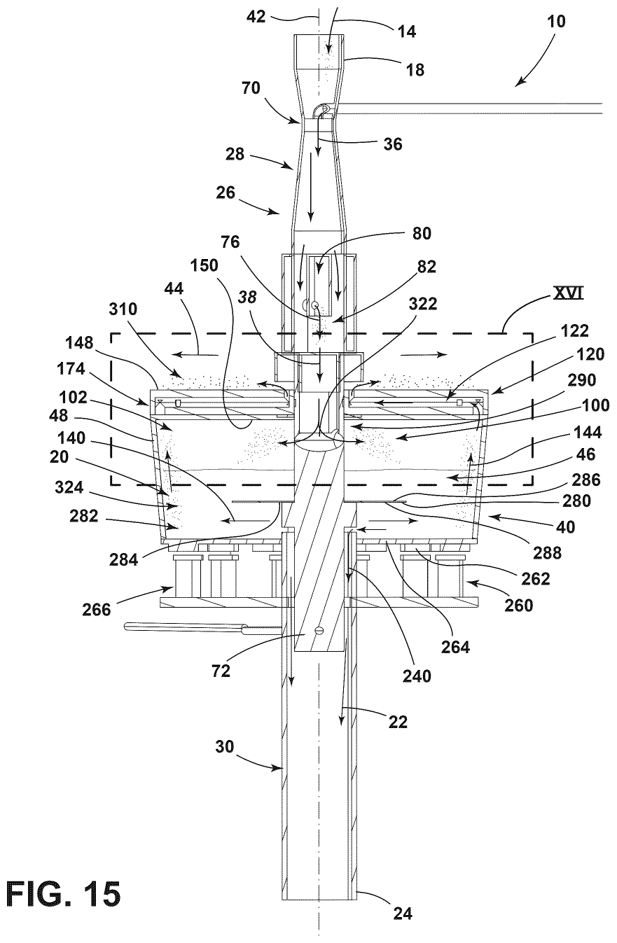

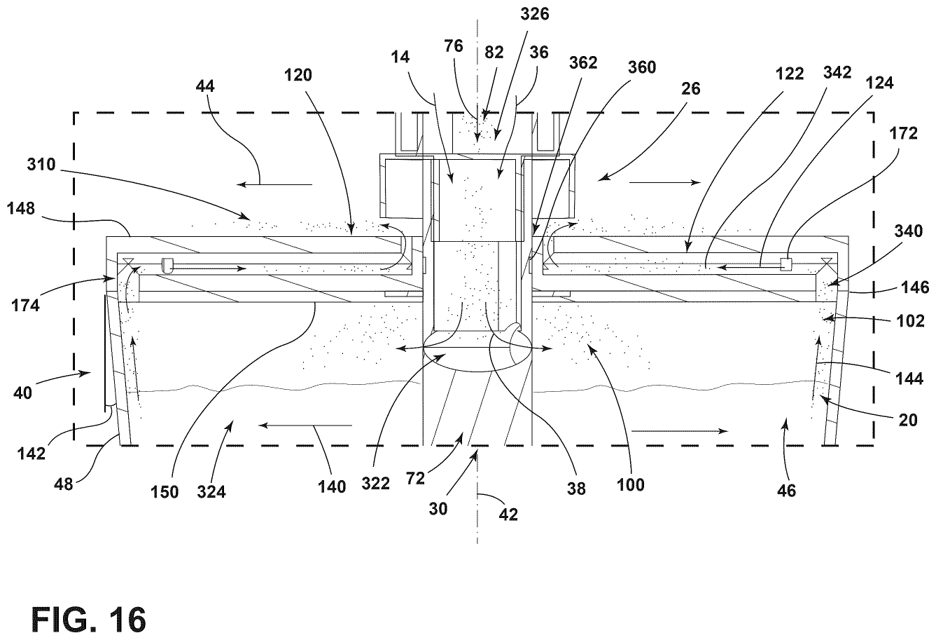

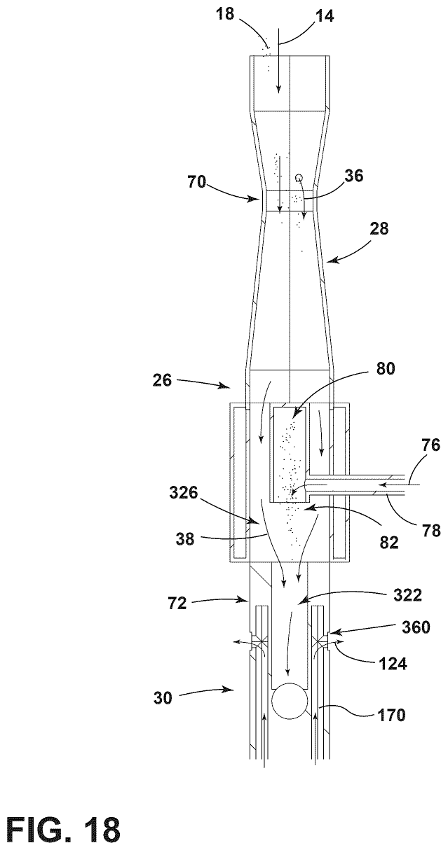

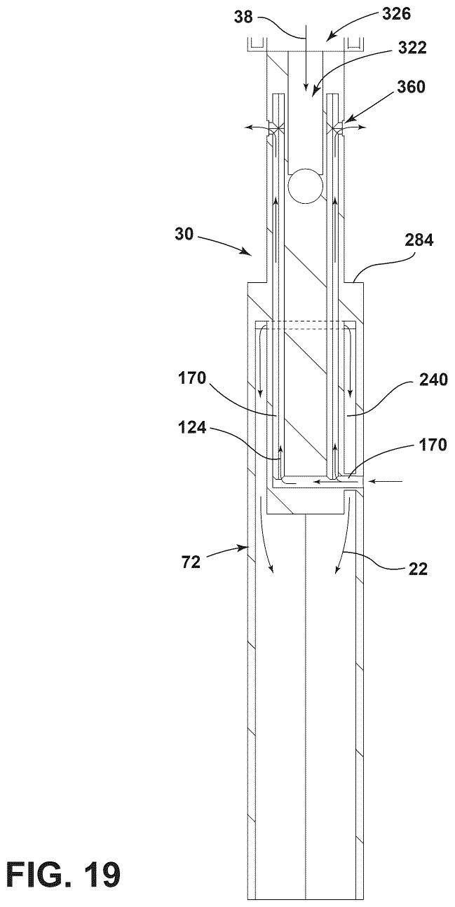

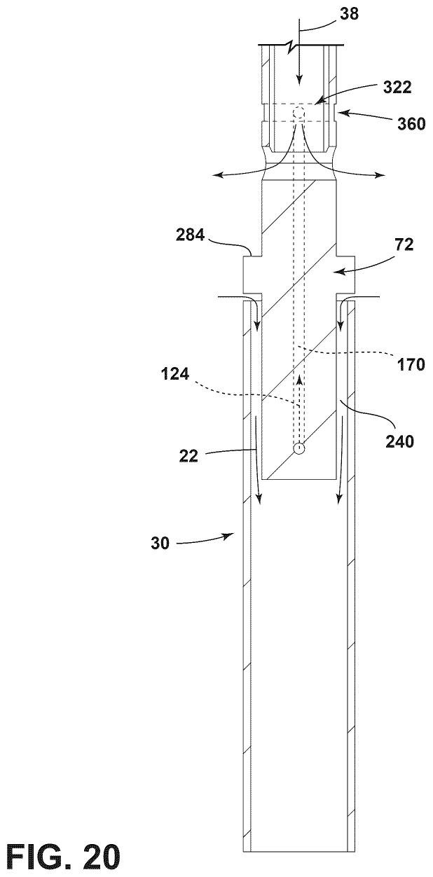

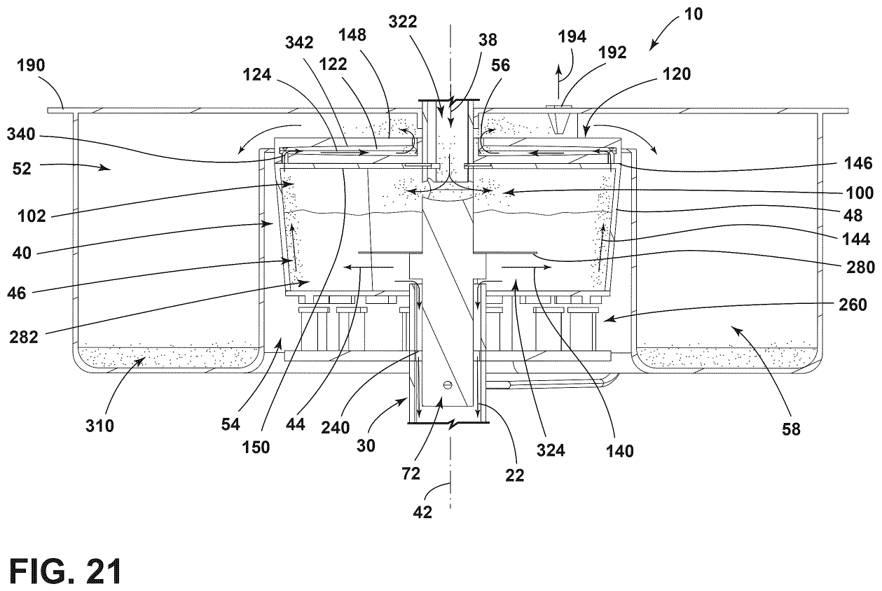

Referring to FIGS. 1-21, reference numeral 10 generally refers to a particle filtration system 10 that is incorporated within an appliance 12 for receiving effluent 14 from a processing chamber 16 and separating the effluent 14 into particulate 18 that can be disposed of as coagulated particles 20, and filtered fluid 22 that can be delivered to an outlet 24 for reuse or disposal within a drain 242 or other similar outlet. According to various aspects of the device, the particle filtration system 10 includes a receiver 26 having an inlet portion 28 and an outlet portion 30. The inlet portion 28 is configured to receive the effluent 14 from a wastewater conduit 32. The wastewater conduit 32 can deliver the effluent 14 from a laundry appliance, dishwasher, or other similar appliance or fixture that gathers soils, microparticles, microfibers, pet hair, and other similar particulate within wastewater, sometimes referred to as greywater. A coagulant reservoir 34 is in communication with the inlet portion 28 of the receiver 26. The inlet portion 28 of the receiver 26 partially combines the effluent 14 and a coagulant 36 from the coagulant reservoir 34 to define a mixed solution 38. A rotor 40 receives the mixed solution 38 from the receiver 26 and rotates about a rotational axis 42. This rotation of the rotor 40 about the rotational axis 42 is used to separate the mixed solution 38 into the coagulated particles 20 and the filtered fluid 22. Rotation of the rotor 40 about the rotational axis 42 generates a centrifugal force 44 that biases the coagulated particles 20 from an interior 46 of the rotor 40 and upward along an angled perimeter wall 48. The filtered fluid 22 is delivered to a drain outlet 50 via the outlet portion 30 of the receiver 26. A collection basin 52 surrounds the rotor 40. The rotor 40 rotates within a central area 54 of the collection basin 52. The collection basin 52 receives the coagulated particles 20 from the angled perimeter wall 48 of the rotor 40.

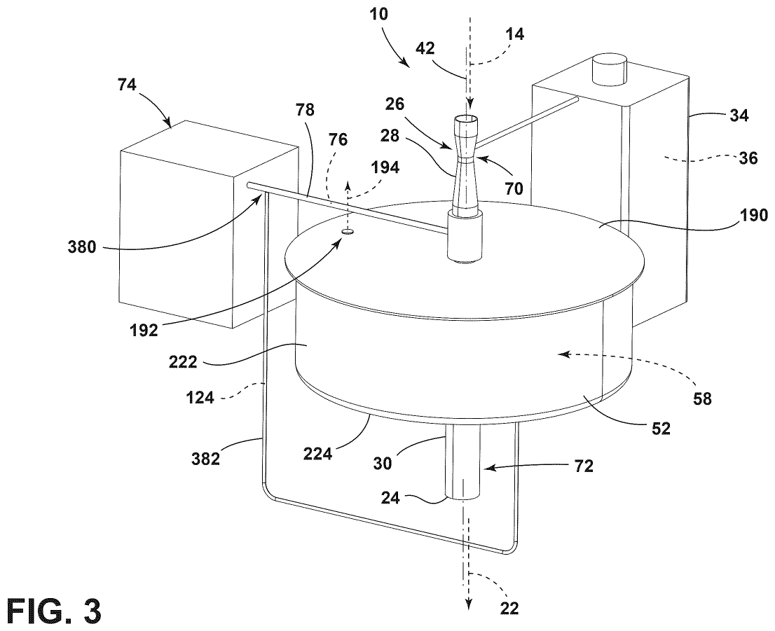

Referring to FIGS. 3-20, the inlet portion 28 of the receiver 26 includes a Venturi section 70 that diffuses the effluent 14 and the coagulant 36 to at least partially define the mixed solution 38. The outlet portion 30 of the receiver 26 includes a distribution shaft 72 that delivers the mixed solution 38 from the inlet portion 28 to the interior 46 of the rotor 40. To assist in the formation of the mixed solution 38, the filtration system 10 includes an air pump 74 that delivers a diffusing airstream 76 into the inlet portion 28 of the receiver 26. This diffusing airstream 76 is delivered via a first air conduit 78 to a portion of the receiver 26 downstream of the Venturi section 70. The diffusing airstream 76 is delivered into the receiver 26, typically via a dispersion chamber 80 that helps to combine the diffusing airstream 76 into the mixture of effluent 14 and coagulant 36. Within and around the dispersion chamber 80, the diffusing airstream 76 is converted into air bubbles, typically in the form of microbubbles 82, that assist in formation of the mixed solution 38. These microbubbles 82 operate with the coagulant 36 to capture and coalesce the particulate 18 of the effluent 14 into the coagulated particles 20. Typically, the dispersion chamber 80 is centrally located within the receiver 26 so that the diffusing airstream 76 can be evenly distributed through the mixture of effluent 14 and coagulant 36 to properly mix these components together to form the mixed solution 38.

Referring again to FIGS. 3-20, the outlet portion 30 of the receiver 26 includes the distribution shaft 72 that delivers the mixed solution 38 from the inlet portion 28 to the interior 46 of the rotor 40. As the mixed solution 38 is delivered into the rotor 40, the microbubbles 82 can be used to capture finer particles of the particulate 18 and generate a foam 100 that collects within the rotor 40. This foam 100 tends to rise above the coagulated particles 20 and the filtered fluid 22 within an upper portion 102 of the rotor 40. As described more fully herein, the rotor 40 and the distribution shaft 72 include various features that assist in the separation of the foam 100 from the filtered fluid 22 and the coagulated particles 20.

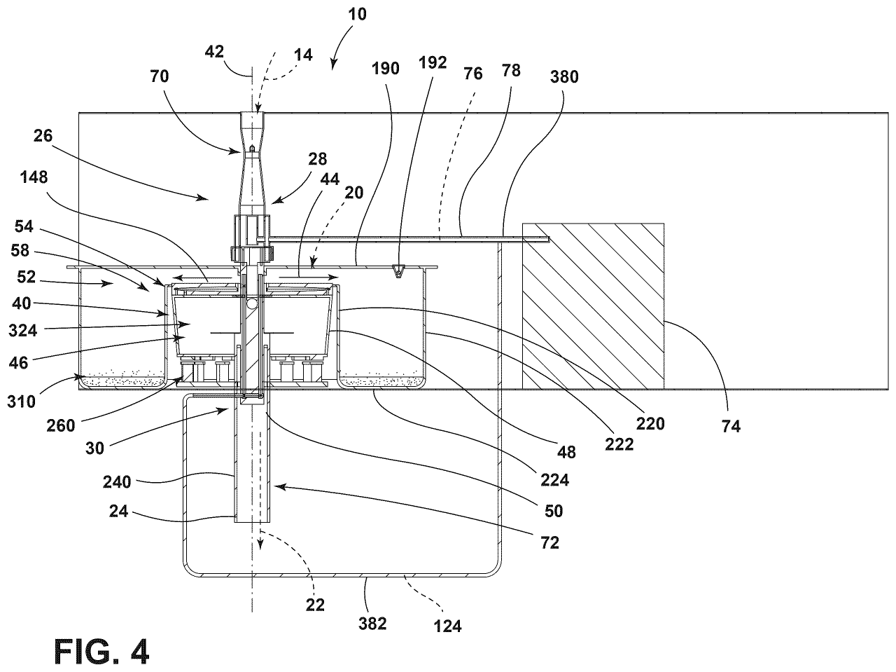

Referring now to FIGS. 4-16, the rotor 40 includes a processing cap 120 that delivers the coagulated particles 20 from the angled perimeter wall 48 and through a plurality of drying channels 122 that extend inward toward the receiver 26. The coagulated particles 20 are moved through the plurality of drying channels 122 using a delivery airstream 124 that is delivered by the air pump 74 and into the distribution shaft 72 of the receiver 26. In certain aspects of the device, the diffusing airstream 76 and the delivery airstream 124 can be delivered by dedicated air pumps 74.

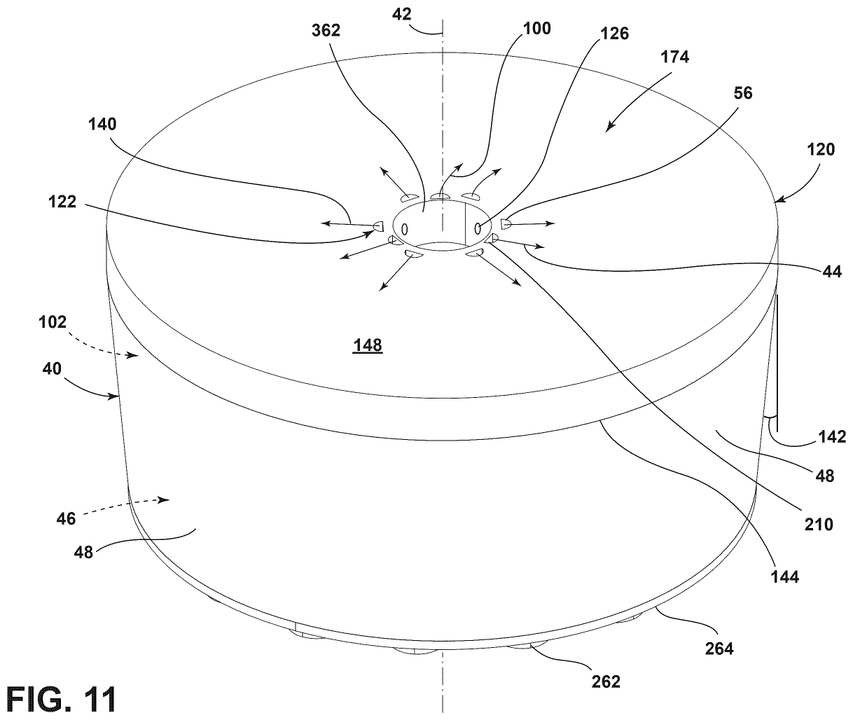

Referring again to FIGS. 4-16, during operation of the rotor 40, the mixed solution 38 is rotated within the interior 46 of the rotor 40. Centrifugal force 44 generated through rotation of the rotor 40 about the rotational axis 42 causes the coagulated particles 20 to be biased in a generally outward direction 140. The angled perimeter wall 48 of the rotor 40 utilizes this centrifugal force 44, in conjunction with the outwardly extending angle 142 of the angled perimeter wall 48 to move the coagulated particles 20 in a generally upward direction 144 and toward the drying channels 122 of the processing cap 120. The drying channels 122 can be defined within the processing cap 120 or can be attached to a portion of the processing cap 120, typically an underside 150 of the processing cap 120. The coagulated particles 20 are biased by the centrifugal force 44 from an upper edge 146 of the angled perimeter wall 48 and into the drying channels 122. The drying channels 122 lead to respective outlet ports 56 that are defined within an upper surface 148 of the processing cap 120 and adjacent to the distribution shaft 72. As exemplified in FIG. 11, the processing cap 120 includes six separate drying channels 122 that extend from the angled perimeter wall 48 to respective outlet ports 56 that are defined within the upper surface 148 of the processing cap 120.

Referring again to FIGS. 4-16, to assist in the movement of the coagulated particles 20, and also to at least partially dry the coagulated particles 20, a plurality of air channels 126 are located within the processing cap 120 for the transport of the delivery airstreams 124 from the air pump 74. The delivery airstreams 124 are directed through the distribution shaft 72 and into the processing cap 120. The distribution shaft 72 includes internal air pathways 170 that receive the delivery airstream 124 from the air pump 74 and carry the delivery airstream 124 into air channels 126 that extend from the distribution shaft 72. The air channels 126 then extend to the drying channels 122. In certain aspects of the device, each air channel 126 can transport the delivery airstream 124 to a corresponding drying channel 122. As exemplified herein, the air channels 126 can extend from the distribution shaft 72 and outward to a branch channel 172 that divides the delivery airstream 124 to be carried into two adjacent drying channels 122. Accordingly, the processing cap 120 delivers the coagulated particles 20 from an outer region 174 of the processing cap 120, near the upper edge 146 of the angled perimeter wall 48, and inward to the respective outlet ports 56 that are located proximate the receiver 26. Contemporaneously, the delivery airstreams 124 are carried from the distribution shaft 72 and through the air channels 126 in an outward direction 140 from the area proximate the distribution shaft 72 and to the branch channels 172. The branch channels 172 are located within the outer region 174 of the processing cap 120 and proximate the upper edge 146 of the angle perimeter wall 48. The branch channels 172 then transport the delivery airstreams 124 from the air channels 126 and into the drying channels 122. The delivery airstreams 124 assist in forcing, biasing, or otherwise transporting the coagulated particles 20 through the drying channels 122 and toward the respective outlet ports 56 of the processing cap 120. As described herein, the delivery airstreams 124 assist in transporting the coagulated particles 20. The delivery airstreams 124 also assist in drying the coagulated particles 20 by evaporating portions of liquid that may be contained within the coagulated particles 20. The delivery airstreams 124 move the coagulated particles 20 through the respective outlet ports 56 onto the upper surface 148 of the processing cap 120 via the respective outlet ports 56.

Referring to FIGS. 4-16 and 21, when the now-dried coagulated particles 20 are disposed on the upper surface 148 of the processing cap 120, the coagulated particles 20 can be referred to as agglomerates 310 of particulate 18. Operation of the rotor 40 and the processing cap 120, about the rotational axis 42, generates the centrifugal force 44 that again biases the at least partially dried coagulated particles 20, or agglomerates 310, along the upper surface 148 and away from the receiver 26 and in the outward direction 140 towards the collection basin 52. The centrifugal force 44 sends the coagulated particles 20 off from the upper surface 148 of the processing cap 120 and into the interior cavity 58 of the collection basin 52. This process is repeated over a number of cycles to at least partially fill the interior cavity 58 of the collection basin 52 that surrounds the rotor 40.

Referring again to FIGS. 4-16 and 21, as the interior cavity 58 of the collection basin 52 fills with agglomerates 310, air from diffusing airstream 76 that forms the foam 100 and air from the delivery airstream 124 that moves and dries the coagulated particles 20 is able to escape the collection basin 52 via one or more vents 192 that are positioned within a cover 190 of the collection basin 52. This vent 192, or plurality of vents 192, can include a valve that allows air or other gas 194 to escape only when the pressure inside the collection basin 52 reaches or exceeds certain pressure limits. Accordingly, the one or more vents 192 can be used to regulate the amount of gas 194, in the form of the diffusing airstream 76, the delivery airstream 124 and other effluent gasses, that can be expelled from the collection basin 52.

Referring again to FIGS. 4-16, the foam 100 is generated through the combination of the diffusing airstream 76 with the effluent 14 and the coagulant 36 to form the mixed solution 38. This foam 100 typically collects within the upper portion 102 of the rotor 40. As additional amounts of mixed solution 38 are added to the interior 46 of the rotor 40, the amount of foam 100 also typically increases. Additionally, during operation of the filtration system 10, added amounts of mixed solution 38 are separated into the coagulated particles 20, the foam 100 and the filtered fluid 22. The increasing amount of filtered fluid 22 and coagulated particles 20 pushes the also increasing amounts of foam 100 in an upward direction 144 and toward the underside 150 of the processing cap 120. The processing cap 120 includes foam vents 210 that allow portions of the foam 100 to escape the rotor 40. This foam 100 leaving the foam vents 210 can collect on the upper surface 148 of the processing cap 120. Typically, the foam vents 210 are defined within the processing cap 120 at a position near the receiver 26. As with the coagulated particles 20 on the upper surface 148, centrifugal force 44 generated by rotation of the rotor 40 about the rotational axis 42 causes the coagulated particles 20 and the collected foam 100 to move in an outward direction 140 according to the centrifugal force 44. The centrifugal force 44 urges the coagulated particles 20 and the accumulated foam 100 off from the upper surface 148 of the processing cap 120 and into the interior cavity 58 of the collection basin 52.

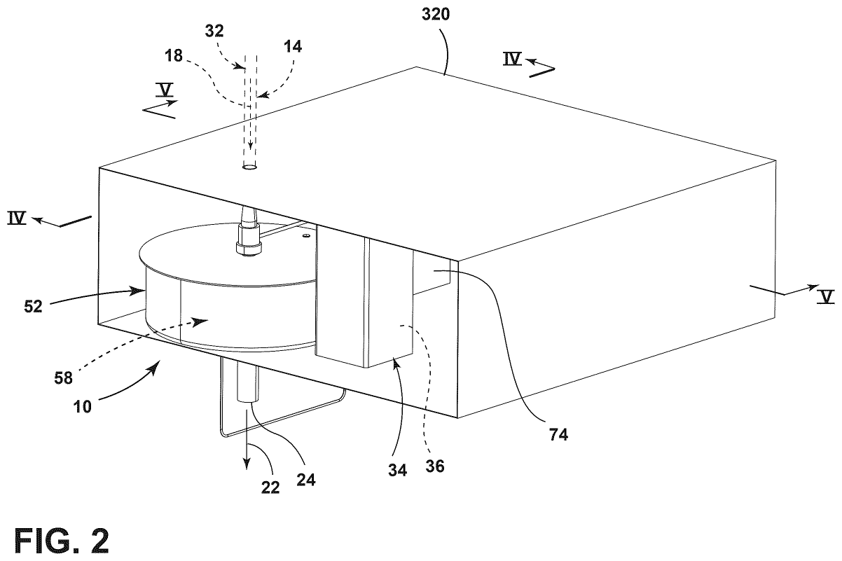

Referring again to FIGS. 2-6 and 21, typically, the collection basin 52 includes an inner wall 220 that surrounds the rotor 40 and defines the central area 54 within which the rotor 40 rotates. The collection basin can also include an outer wall 222 that defines an outer boundary of the collection basin 52. The inner wall 220 and the outer wall 222 are connected via a base 224 that extends around the collection basin 52 to define the interior cavity 58 for the collection basin 52. As described herein, the collection basin 52 includes a cover 190 having at least one vent 192 positioned within the cover 190 to allow gas 194 to escape as gas 194 collects within the collection basin 52. Through this configuration, the rotor 40 is able to rotate within the central area 54 of the collection basin 52 to generate the centrifugal force 44 needed for moving the coagulated particles 20 up the angled perimeter wall 48 of the rotor 40 and to the drying channels 122 and also for moving the coagulated particles 20 and the collected foam 100 from the upper surface 148 of the processing cap 120 in the outward direction 140 and into the collection basin 52.

Referring again to FIGS. 1-21, the filtered fluid 22 that collects within the interior 46 of the rotor 40 can be delivered to a drain 242 via the distribution shaft 72. The distribution shaft 72 includes a fluid outlet 240 that allows the filtered fluid 22 to be removed from the interior 46 of the rotor 40 into a drain 242 that is external to the appliance 12, or to a recirculation path that delivers the filtered fluid 22 back into the appliance 12 for use. According to various aspects of the device, the filtered fluid 22 can be reused for certain functions such as reuse within the appliance 12. In the case of a laundry appliance 12, the filtered fluid 22 can be used for delivering detergent or other treating materials from a reservoir into the processing space. In certain aspects of the device, it is contemplated that the filtered fluid 22 can be reused within a household or other structure for certain non-potable purposes, such as process fluid within other appliances, flush water for water closets and toilet, watering plants, and other similar non-potable purposes.

Referring now to FIGS. 4-15, rotation of the rotor 40 can be accomplished through any one of various motors or other drive mechanism 260. As exemplified herein, the rotor 40 can include a plurality of rotor magnets 262 that are attached to a bottom wall 264 of the rotor 40. A plurality of electromagnetic poles 266 can be positioned below the rotor 40 and in electromagnetic communication with the rotor magnets 262. As the poles 266 are energized, electromagnetic fields are produced that cooperate with the rotor magnets 262 to produce an electromagnetic force that biases the rotor magnets 262, and, in turn, the rotor 40 to operate about the rotational axis 42. The poles 266 that are positioned below the rotor 40 can include a stator 268 having a plurality of teeth 270 and windings 272 that are disposed around the teeth 270 of the stator 268. As the windings 272 are energized, the electromagnetic field is produced that interacts with the rotor magnets 262 to produce the electro-motive force that rotates the rotor 40 about the rotational axis 42. It is contemplated that the rotor 40 can be operated through a wide range of direct drive mechanisms 260. Such drive mechanisms 260 can include, but are not limited to, a belt-driven motor, direct drive motors, and other similar drive mechanisms.

Referring now to FIGS. 4-10 and 13-21, the distribution shaft 72 can include a separation member 280 that divides the interior 46 of the rotor 40 between the upper portion 102 and a lower portion 282. As described herein, foam 100 that is produced during the processing of the effluent 14, due to its minimal density, tends to collect in the upper portion 102 of the interior 46 for the rotor 40 and on top of the filtered fluid 22. The separation member 280 assists in causing this division between the foam 100 and the filtered fluid 22 that collects within the lower portion 282 of the interior 46 for the rotor 40, particularly where the level of the filtered fluid 22 is below the separation member 280. The separation member 280 can be a statically positioned member that is attached to distribution shaft 72. In such an aspect of the device, the separation member 280 can rest on and attach to a ledge 284 of the distribution shaft 72. It is also contemplated that the separation member 280 can have a density that causes it to float on the filtered fluid 22 but remain beneath the foam 100 such that the foam 100 is positioned above a top surface 286 of the separation member 280 and the filtered fluid 22 is positioned below a bottom surface 288 of the separation member 280.

Referring again to FIGS. 4-10 and 13-21, the separation member 280 can be useful in dividing and separating the foam 100 from the filtered fluid 22 so that the foam 100 can effectively move upward and toward the foam vents 210 that are positioned within the processing cap 120 of the rotor 40. It is contemplated that the separation member 280 has a diameter that is smaller than the diameter of the interior 46 for the rotor 40. This smaller size allows the coagulated particles 20 to move in the outward direction 140 along the bottom wall 264 of the rotor 40 and in the upward direction 144 along the angled perimeter wall 48 of the rotor 40 under the centrifugal force 44. The smaller diameter of the separation member 280 allows the coagulated particles 20 to move in the upward direction 144 and past the separation member 280. As discussed herein, the centrifugal force 44 moves the coagulated particles 20 from the bottom wall 264, up the angled perimeter wall 48 and into the drying channels 122 for the processing cap 120. Contemporaneously, the size of the separation member 280 allows for the foam 100 to separate and be disposed above a top surface 286 of the separation member 280 to be moved toward the foam vents 210 of the processing cap 120.

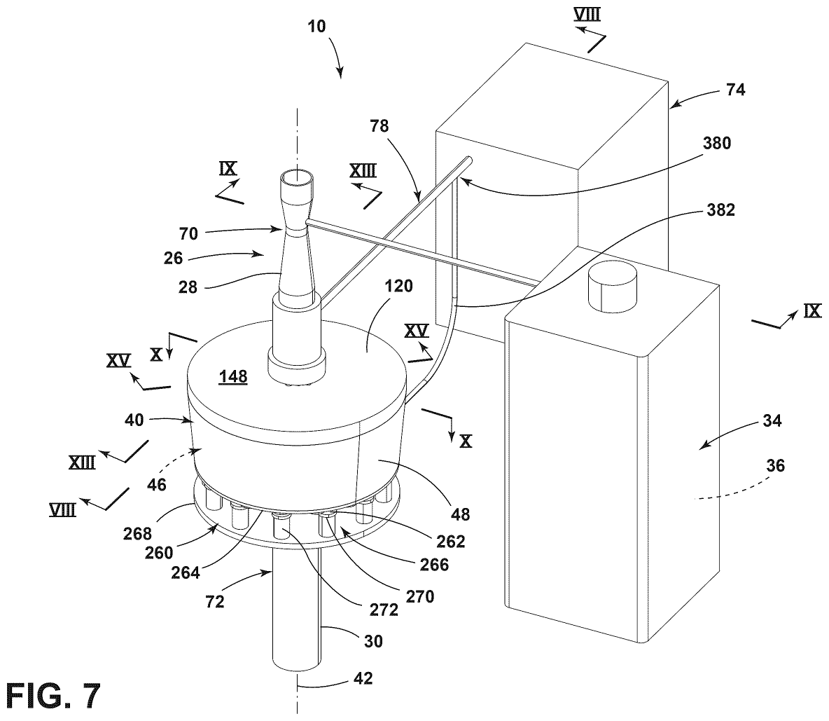

Referring now to FIGS. 7-11 and 13-21, the upper surface 148 of the processing cap 120 includes a series of perforations that define the foam vents 210 and the outlet ports 56. Through this positioning, the foam 100 and the coagulated particles 20 can be delivered to the upper surface 148 of the processing cap 120. Once on the upper surface 148 of the processing cap 120, the foam 100 and the coagulated particles 20, or agglomerates 310, can be moved in the outward direction 140 and toward the collection basin 52 through the application of the centrifugal force 44.

Referring again to FIGS. 7-11 and 13-21, the outlet ports 56 and the foam vents 210 are positioned within an interior region 290 of the rotor 40 and near the receiver 26. This positioning allows the delivery airstreams 124 to operate on the coagulated particles 20 to at least partially dry the coagulated particles 20 into the agglomerates 310. As the coagulated particles 20 at least partially dry into the agglomerates 310, these agglomerates 310 can become more conveniently moved through the drying channels 122 and along the upper surface 148 of the processing cap 120. Additionally, by drying the coagulated particles 20, the coagulated particles 20 can coalesce into more solid and larger particles that are made up of the various particulate 18 of the effluent 14 as well as the coagulant 36. This combination of materials forms the plurality of agglomerates 310 that can be at least partially solidified for convenient movement through the drying channels 122 and across the upper surface 148 of the processing cap 120. Additionally, these agglomerates 310 can be more convenient to remove from the interior cavity 58 of the collection basin 52 for recycling and/or disposal.

Referring now to FIGS. 2-5 and 21, the agglomerates 310 that are collected within the collection basin 52 can be removed from the interior cavity 58 of the collection basin 52 by separating the cover 190 from the remainder of the collection basin 52 and removing the agglomerates 310 from the interior cavity 58 of the collection basin 52. This can be accomplished by suction, scooping, and other similar operations. These agglomerates 310 of various particles can be disposed of, recycled, or otherwise removed from the collection basin 52.

Referring again to FIGS. 1-21, the particulate filtration system 10 can be disposed within a pedestal 320 for an appliance 12. The filtration system 10 includes the receiver 26 having the inlet portion 28 that receives the effluent 14 from the appliance 12. The receiver 26 includes a diffuser 326 that combines the effluent 14 with the coagulant 36 from the coagulant reservoir 34 to at least partially define the mixed solution 38. The distribution shaft 72 receives the mixed solution 38 from the diffuser 326 of the receiver 26 and delivers the mixed solution 38 to an effluent pathway 322 of the distribution shaft 72. The distribution shaft 72 includes an internal air pathway 170 and the fluid outlet 240. According to various aspects of the device, the effluent pathway 322, the internal air pathway 170, and the fluid outlet 240 are all contained within the distribution shaft 72 and are separated from one another. The rotor 40 rotates about the rotational axis 42 to produce the centrifugal force 44. The rotor 40 receives the mixed solution 38 from the effluent pathway 322. The interior 46 of the rotor 40 includes a separating chamber 324 that separates the mixed solution 38 using the centrifugal force 44 into the filtered fluid 22, the coagulated particles 20 and the foam 100 that is produced through the addition of the diffusing airstreams 76 from the air pump 74.

As described herein, the coagulated particles 20, the foam 100 and the filtered fluid 22 are each delivered from the separating chamber 324 of the rotor 40 through a dedicated path. The coagulated particles 20 are delivered from the rotor 40 via the drying channels 122, the foam 100 is delivered via the foam vents 210, and the filtered fluid 22 is delivered through the fluid outlet 240 of the distribution shaft 72. The processing cap 120 receives the coagulated particles 20 from the angled perimeter wall 48 of the rotor 40 and delivers the coagulated particles 20 from the rotor 40 onto the upper surface 148 of the processing cap 120. The air pump 74 delivers the delivery airstreams 124 through the internal air pathway 170 of the distribution shaft 72 and into the air channels 126 of the processing cap 120. The delivery airstream 124 at least partially moves the coagulated particles 20 through drying channels 122 and onto the upper surface 148 of the processing cap 120. The centrifugal force 44 biases the coagulated particles 20 from the upper surface 148 of the processing cap 120 and to the collection basin 52 that surrounds the rotor 40.

As described herein, the air pump 74 also delivers the diffusing airstreams 76 to the diffuser 326 that assist in forming the mixed solution 38 within the inlet portion 28 of the receiver 26. The diffusing airstream 76 also forms the foam 100 that collects within the rotor 40. As described herein, the foam 100 can be useful in capturing smaller sized particulate 18 or particulate 18 having a lower density that may be contained within the effluent 14. Accordingly, particulate that may tend to float on the filtered fluid 22 may tend to be collected within the foam 100. Particulate that may tend to sink or suspend within the effluent 14 or the filtered fluid 22 may tend to collect with the coagulant 36 to form the coagulated particles 20.

Referring again to FIGS. 4-9 and 13-21, the receiver 26 includes the Venturi section 70 and a coagulant inlet that is positioned proximate the Venturi section 70. The Venturi section 70 can be configured as a Venturi tube that uses the pressure differential created within the Venturi tube of the Venturi section 70 to draw the coagulant 36 from the coagulant reservoir 34. In the manner, the coagulant 36 may only be dispensed when the effluent 14 moves through the Venturi section 70. It is also contemplated that the coagulant reservoir 34 can include a pump that delivers the coagulant 36 into the inlet portion 28 of the receiver 26. The Venturi section 70 converts the effluent 14 and the delivered coagulant 36 into a fast-moving stream of fluid that is delivered past the dispersion chamber 80. At the dispersion chamber 80, the fast-moving stream of fluid that contains the effluent 14 and the coagulant 36 is combined with the microbubbles 82 from the diffusing airstream 76. The combination of the microbubbles 82, the effluent 14 and the coagulant 36 within the diffuser 326 operates to combine these materials. This movement of material through the diffuser 326 also assists in the coagulant 36 and the microbubbles 82 capturing the particulate 18 of the effluent 14 and converting the particulate 18 into at least one of the coagulated particles 20 and the foam 100.

Referring again to FIGS. 4-9 and 13-21, the distribution shaft 72 engages the inlet portion 28 downstream of the Venturi section 70. The effluent pathway 322, the internal air pathway 170, and the fluid outlet 240 are separate from one another within the distribution shaft 72. The effluent pathway 322, as described herein, receives the mixed solution 38 from the diffuser 326 and delivers the mixed solution 38 into the separating chamber 324 within the interior 46 of the rotor 40. The internal air pathway 170 receives the delivery airstreams 124 from the air pump 74 and delivers the delivery airstreams 124 into the air channels 126 of the processing cap 120. The delivery airstreams 124 are then moved from the air channels 126, through the branch channels 172 and into the drying channels 122. The coagulated particles 20 are thereby moved toward the respective outlet ports 56 defined within the processing cap 120. The drying channels 122 include an inlet port 340 proximate the upper edge 146 of the angled perimeter wall 48. The respective outlet ports 56 are positioned at opposing ends of the drying channels 122, opposite the inlet ports 340. The coagulated particles 20 move upward into the drying channel 122 through the inlet ports 340, then along a transverse section 342 of the drying channel 122 and then upward to the upper surface 148 of the processing cap 120 via the outlet ports 56. The branch channels 172 that direct the delivery airstreams 124 from the air channels 126 and to the drying channels 122 engage the drying channels 122 proximate the intersection of the inlet port 340 and the transverse section 342 of each drying channel 122. In this manner, the delivery airstreams 124 assist in moving the coagulated particles 20 along the drying channels 122 and out the outlet ports 56 and to the upper surface 148 of the processing cap 120.

Referring again to FIGS. 2-21, operation of the drive mechanism 260 rotates the rotor 40 about the rotational axis 42. This motion of the rotor 40 also rotates the processing cap 120 about the rotational axis 42 to generate the centrifugal force 44 that moves the coagulated particles 20 from the separation member 280 within the rotor 40, upward along the angled perimeter wall 48 and into the drying channels 122 of the processing cap 120. The movement of the delivery airstreams 124 through the air channels 126 and into the drying channels 122 can be used to overcome the centrifugal force 44 and move the coagulated particles 20 through the drying channels 122 into the respective outlet ports 56. In this manner, the air pump 74 can deliver a sufficient magnitude of the delivery airstream 124 to bias the coagulated particles 20 through the drying channels 122 such that the force of the air pressure of the delivery airstream 124 overcomes the centrifugal force 44 for transporting the coagulated particles 20 to the respective outlet ports 56.

It is also contemplated that operation of the rotor 40 can occur in stages such that the rotor 40 rotates to bias the coagulated particles 20 upward along the angled perimeter wall 48 and into the drying channels 122. When a sufficient amount of the coagulated particles 20 are positioned within the drying channels 122, operation of the rotor 40 can slow or cease. When the rotor 40 is slowed or stopped and the centrifugal force 44 is diminished or stopped, the air pump 74 can deliver the delivery airstreams 124 into the air channels 126 so that the collected coagulated particles 20 can be moved through the drying channels 122 and to the respective outlet ports 56 for deposition on the upper surface 148 of the processing cap 120. Once the coagulated particles 20 have been moved to the upper surface 148 of the processing cap 120, the drive mechanism 260 can speed up or restart to produce the centrifugal force 44 to deliver the coagulated particles 20, or the agglomerates 310 into the collection basin 52.

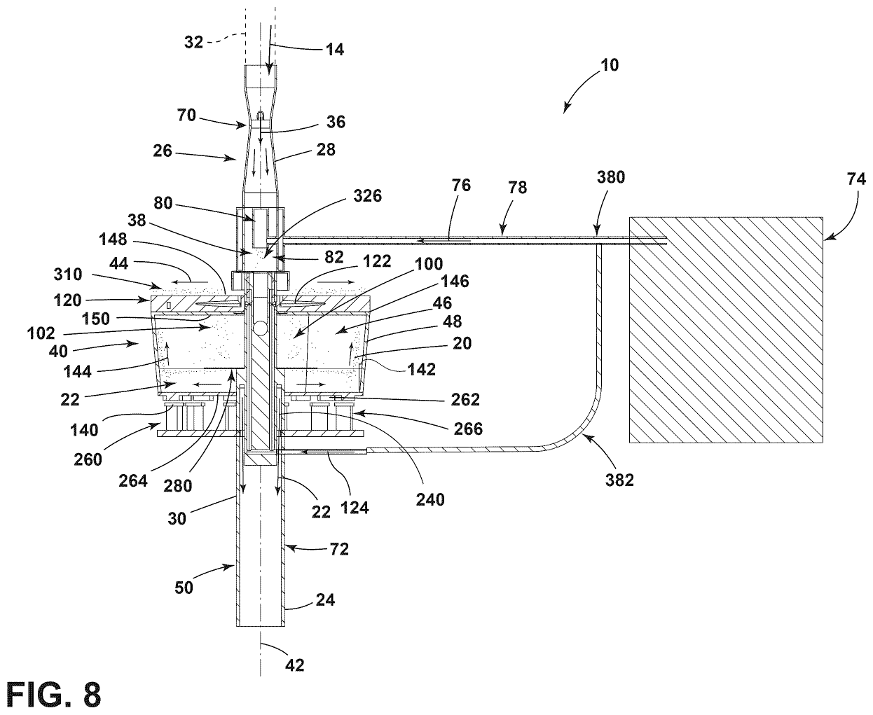

Referring again to FIGS. 8-10 and 13-21, typically, the delivery airstreams 124 are delivered through the air channels 126 during rotation of the rotor 40. Because the rotor 40 and the air channels 126 rotate about the distribution shaft 72, the distribution shaft 72 includes a circumferential channel 360 that extends around the outer surface of the distribution shaft 72. Through this configuration, the internal air pathways 170 of the distribution shaft 72 are coupled with the air channels 126 of the processing cap 120 through an operable sealing assembly 362 that allows for the movement of air from the internal air pathway 170 and into the air channels 126 of the processing cap 120 regardless of the rotational orientation of the processing cap 120 with respect to the internal air pathway 170 of the distribution shaft 72. The operable sealing assembly 362 provides for this movement of the delivery airstream 124 without allowing portions of the delivery airstream 124 to escape outside the processing cap 120, except through the air channels 126, the branch channels 172 and the drying channels 122. The operable sealing assembly 362 and the circumferential channel 360 allows for rotation the processing cap 120 relative to the distribution shaft 72, while also providing a substantially airtight seal to direct the delivery airstreams 124 from the air pump 74, through the internal air pathways 170 of the distribution shaft 72, and into the air channels 126 of the processing cap 120.

According to various aspects of the device, as exemplified in FIGS. 1-21, the receiver 26, including the Venturi section 70 and the distribution shaft 72, are generally static relative to the rotor 40 such that the rotor 40 rotates around the distribution shaft 72 and the remainder of the receiver 26. This allows the coagulant 36, the diffusing airstream 76 and the delivery airstreams 124 to be delivered into the receiver 26 during operation of the filtration system 10. It is contemplated that various operable seals can be included around the engagement between the coagulant reservoir 34 and the air pump 74 with the receiver 26 to offer certain rotational motion of the receiver 26 with respect to the coagulant reservoir 34 and the air pump 74.

According to various aspects of the device, as exemplified in FIGS. 3-4 and 6-8, the air pump 74 delivers both the diffusing airstream 76 and the delivery airstreams 124 into the receiver 26. The air pump 74 can be attached to the first air conduit 78 that includes an air valve 380 that separates the air provided by the air pump 74 into separate streams that form the diffusing airstream 76 delivered into the upper portion 102 of receiver 26, and the delivery airstream 124 that is delivered within the internal air pathway 170 of the distribution shaft 72. The air valve 380 can operate to allow for the simultaneous or contemporaneous delivery of the diffusing airstream 76 and the delivery airstream 124. In such an aspect of the device, the air valve 380 operates to maintain a substantially consistent air pressure within the first air conduit 78 that delivers the diffusing airstream 76 and a second air conduit 382 that delivers the delivery airstream 124.

It is also contemplated that the air valve 380 can operate to alternatively provide air between the first air conduit 78 and the second air conduit 382. In such an aspect of the device, it is contemplated that the air valve 380 operates to open the first air conduit 78 and close the second air conduit 382. At an appropriate point in operation of the filtration system 10, the air valve 380 can operate to close the first air conduit 78 and open the second air conduit 382. The timing for operation of the first and second air conduits 78, 382 can coincide with any one of various points within operation of the filtration system 10. Such points can be stopping and starting of the drive mechanism 260 that rotates the rotor 40 about the rotational axis 42 upon the delivery of effluent 14 into the receiver 26, accumulation of material on the upper surface 148 of the processing cap 120, and other similar points within operation of the filtration system 10.

Referring again to FIGS. 1-21, the filtration system 10 includes the receiver 26 having a Venturi section 70 that receives and combines effluent 14 with a coagulant 36 from the coagulant reservoir 34 to define the mixed solution 38. The distribution shaft 72 receives the mixed solution 38 from the Venturi section 70. The distribution shaft 72 includes the effluent pathway 322 that delivers the mixed solution 38 into the rotor 40, an internal air pathway 170 that delivers the delivery airstreams 124 from the air pump 74 and into the air channels 126 of the processing cap 120, and the fluid outlet 240 that delivers the filtered fluid 22 from the interior 46 of the rotor 40 and to the drain 242 for the filtration system 10. As described herein, the effluent pathway 322, the internal air pathway 170, and the fluid outlet 240 are all contained within the distribution shaft 72 and are separate from one another to define separate and distinct passages within the distribution shaft 72. The rotor 40 rotates about the rotational axis 42 to produce the centrifugal force 44. The rotor 40 includes the interior separating chamber 324 that receives the mixed solution 38 from the effluent pathway 322. Rotation of the rotor 40 separates the mixed solution 38 using the centrifugal force 44 to define the filtered fluid 22 and the coagulated particles 20. The coagulated particles 20 are biased by the centrifugal force 44 to move upward along an angled perimeter wall 48 of the interior separating chamber 324. The filtered fluid 22 is directed into the fluid outlet 240 of the distribution shaft 72. The filtered fluid 22 can be directed into the fluid outlet 240 during rotation of the rotor 40 as well as when the rotor 40 has stopped rotating. During rotation of the rotor 40, the coagulated particles 20 are biased against the angled perimeter wall 48 of the rotor 40. The filtered fluid 22, being less dense, accumulates within the lower portion 282 of the rotor 40 between the coagulated particles 20 and the distribution shaft 72. The foam 100 collected within the rotor 40 collects above the separation member 280 and above the filtered fluid 22 and near the foam vents 210 defined within the processing cap 120.

Referring again to FIGS. 1-21, the processing cap 120 receives the coagulated particles 20 from the angled perimeter wall 48 and delivers the coagulated particles 20 from the rotor 40 to an upper surface 148 of the processing cap 120 via the drying channels 122 defined within the processing cap 120. The air pump 74 delivers the delivery airstreams 124 through the internal air pathway 170 of the distribution shaft 72 and into the processing cap 120. The delivery airstream 124 at least partially moves the coagulated particles 20 through the drying channels 122 of the processing cap 120 and to the upper surface 148 of the processing cap 120. The drying channels 122 extend inward from proximate the angled perimeter wall 48 and to an area near the distribution shaft 72. The centrifugal force 44 biases the coagulated particles 20 from the upper surface 148 of the processing cap 120 and into the collection basin 52 that surrounds the rotor 40.

Referring again to FIGS. 4-10 and 13-21, the air channels 126, the branch channels 172 and the drying channels 122 that are incorporated within the processing cap 120 can be attached to the underside 150 of the processing cap 120. It is also contemplated that these air channels 126, branch channels 172, and drying channels 122 can be incorporated within the processing cap 120 through the attachment of a series of layers that are attached to one another to form the structure of the processing cap 120. It is contemplated that the inlet ports 340 of the drying channels 122 can include a funnel-type formation that gathers the coagulated particles 20 from the angled perimeter wall 48 and funnels these coagulated particles 20 into the drying channels 122. It is also contemplated that the transverse section 342 of the drying channels 122 can include a tapered configuration that provides for convenient movement of the coagulated particles 20 through the drying channels 122, through the assistance of the delivery airstreams 124 from the air pump 74.

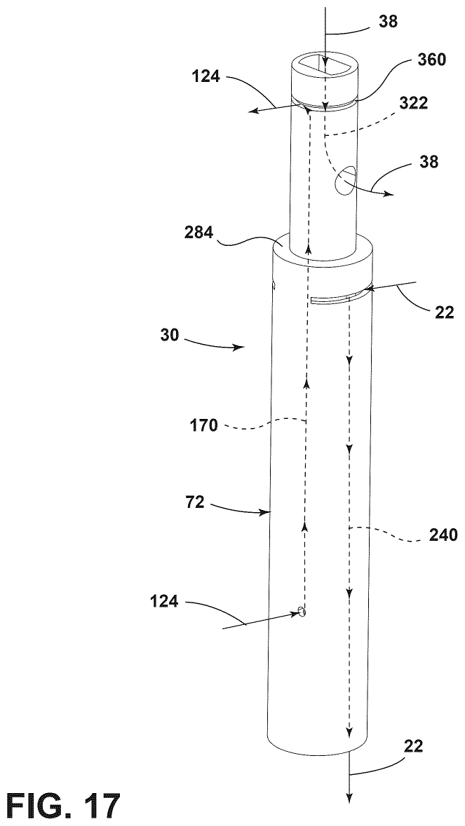

Referring again to FIGS. 17-20, the various internal passageways within the distribution shaft 72 can be symmetrically oriented within the distribution shaft 72. By way of example, and not limitation, each of the effluent pathway 322, the internal air pathway 170, and the fluid outlet 240 can include opposing apertures within the distribution shaft 72 that provide for movement of the effluent 14, the delivery airstream 124, and the filtered fluid 22, respectively, through the distribution shaft 72. It is also contemplated that the various apertures of these passageways can be evenly distributed around the outer surface of the distribution shaft 72 to provide for an even and efficient movement of materials through the filtration system 10, without mixing of the effluent 14, the delivery airstream 124, and the filtered fluid 22. Use of the receiver 26 that includes the Venturi section 70 and the distribution shaft 72 provides for movement of a number of materials through the filtration system 10. Using the receiver 26, the Venturi section 70 and the distribution shaft 72 provides for movement of the effluent 14, coagulant 36, diffusing airstream 76, delivery airstream 124, and filtered fluid 22 into and out from the separating chamber 324 defined within the interior 46 of the rotor 40. Using the receiver 26, these materials are moved through the filtration system 10 to accomplish filtration of the effluent 14 so that coagulated particles 20 and particulate 18 captured within the foam 100 can be removed and disposed of, and the filtered fluid 22 can be delivered for responsible disposal within a municipal water supply or other sewer line, or for reuse within the appliance or within a residential or commercial structure.

According to various aspects of the device, the coagulant 36 described herein can be any one of various materials. Such coagulated materials can include, but are not limited to, water, aluminum sulfate, ferrous sulfate, and other similar coagulants that operate to clot with particles having a greater specific gravity than water. As described herein, these coagulants 36 operate to cause the particulate 18 of the effluent 14 to clot forming the coagulated particles 20 and the foam 100 that can be moved to the collection basin 52.

According to various aspects of the device, as illustrated in FIGS. 2-21, the delivery airstream 124 delivered from the air pump 74 can be in the form of hot air that is delivered through the distribution shaft 72 and into the air channels 126 of the processing cap 120. It is also contemplated that the delivery air conduit can include one or more heaters that operate to heat the delivery airstream 124 such that heated air is moved through the distribution shaft 72 and into the processing cap 120. This heated air operates to evaporate moisture within the coagulated particles 20 and also move the coagulated particles 20 through the drying channels 122. As the coagulated particles 20 dry, they tend to at least partially shrink. By drying and, in certain situations, shrinking the coagulated particles 20, the coagulated particles 20 can move more efficiently through the drying channels 122 of the processing cap 120. Additionally, as the coagulated particles 20 dry to form the agglomerates 310, the agglomerates 310 also become less able to adhere to the walls of the drying channels 122 and tend to move therethrough more smoothly.

As this heated delivery airstream 124 moves through the processing cap 120, the vents 192 defined within the cover 190 of the collection basin 52 allow for this air to escape the collection basin 52. It is also contemplated that the diffusing airstream 76 can also be heated such that the diffusing airstream 76 and the delivery airstream 124 are each heated before they are delivered into the respective passageways of the distribution shaft 72. It is also contemplated that only the delivery airstream 124 is heated and the diffusing airstream 76 remains at a generally ambient temperature. Use of the air pump 74 for delivering the diffusing airstream 76 and the delivery airstream 124 provides a sufficient force of the air moving through the distribution shaft 72 to generate the diffusing effect within the inlet portion 28 of the receiver 26 and also to move the coagulated particles 20 through the drying channel 122 of the processing cap 120. Sufficient air pressure is desired to move the coagulated particles 20 through the processing cap 120 and also to cause the drying action that helps to at least partially solidify the coagulated particles 20 into the agglomerates for disposal into the collection basin 52.

The invention disclosed herein is further summarized in the following paragraphs and is further characterized by combinations of any and all of the various aspects described therein.

According to one aspect of the present disclosure, a particulate filtration system for an appliance includes: a receiver having an inlet portion and an outlet portion, wherein the inlet portion is configured to receive effluent from a wastewater conduit, and wherein the inlet portion at least partially combines the effluent and a coagulant from a coagulant reservoir to define a mixed solution; a rotor that receives the mixed solution from the receiver and rotates about a rotational axis to generate a centrifugal force to separate the mixed solution into coagulated particles and filtered fluid, wherein the centrifugal force biases the coagulated particles from an interior of the rotor and upward along an angled perimeter wall of the rotor, and wherein the filtered fluid is delivered to a drain outlet via the outlet portion of the receiver; and a collection basin that surrounds the rotor, wherein the rotor rotates within a central area of the collection basin, and wherein the collection basin receives the coagulated particles from the angled perimeter wall of the rotor.

According to another aspect, the inlet portion includes a Venturi section that diffuses the effluent and the coagulant to define the mixed solution.

According to another aspect, the outlet portion of the receiver includes a distribution shaft that delivers the mixed solution from the inlet portion to the interior of the rotor.

According to another aspect, an air pump delivers a diffusing airstream into the inlet portion of the receiver that assists in forming the mixed solution.

According to another aspect, the rotor includes a processing cap that delivers the coagulated particles from the angled perimeter wall and through a plurality of drying channels that extend inward toward the receiver, wherein the coagulated particles are moved through the plurality of drying channels using a delivery airstream, wherein the air pump provides the delivery airstream.

According to another aspect, the delivery airstream delivers the coagulated particles to an upper surface of the processing cap.

According to another aspect, the delivery airstream is delivered into the processing cap through an internal air pathway of the distribution shaft.

According to another aspect, the filtered fluid is delivered to the drain outlet via a fluid outlet of the distribution shaft.

According to another aspect, the plurality of drying channels extend from the angled perimeter wall to a plurality of respective ports that deliver the coagulated particles to the upper surface of the processing cap, wherein the centrifugal force biases the coagulated particles from the upper surface of the processing cap and into the collection basin.

According to another aspect, the particulate filtration system further includes a plurality of electromagnetic poles, wherein the electromagnetic poles selectively cooperate with magnets of the rotor to produce an electromotive force that rotates the rotor about the rotational axis.

According to another aspect, the collection basin is separable from the rotor for disposal of the coagulated particles within the collection basin.

According to another aspect, the distribution shaft includes a separation member that divides the interior of the rotor between an upper portion and a lower portion, wherein the filtered fluid accumulates within the lower portion and wherein foam that is generated during the operation of the rotor at least partially accumulates within the upper portion above the separation member.

According to another aspect, the processing cap includes at least one vent proximate the distribution shaft, wherein the vents are in communication with the upper portion of the rotor and with an upper surface of the processing cap, wherein in response to the foam accumulating within the upper portion, at least a portion of the foam is delivered through the at least one vent and to the upper surface of the processing cap.

According to another aspect of the present disclosure, a particulate filtration system for an appliance pedestal includes: a receiver that receives effluent, wherein the receiver includes a diffuser that combines a coagulant with the effluent to at least partially define a mixed solution; a distribution shaft that receives the mixed solution from the receiver, the distribution shaft having an internal air pathway and a fluid outlet; a rotor that rotates about a rotational axis to produce a centrifugal force, wherein the rotor receives the mixed solution from an effluent pathway of the distribution shaft, the rotor including a separating chamber that separates the mixed solution using the centrifugal force into a filtered fluid and coagulated particles, wherein the filtered fluid is delivered away from the rotor via the fluid outlet; a processing cap that receives the coagulated particles from an angled perimeter wall of the rotor and delivers the coagulated particles from the rotor and to an upper surface of the processing cap; and an air pump that delivers a delivery airstream through the internal air pathway of the distribution shaft and into the processing cap, wherein the delivery airstream at least partially moves the coagulated particles through drying channels of the processing cap and to the upper surface, and wherein the centrifugal force biases the coagulated particles from the upper surface of the processing cap to a collection basin that surrounds the rotor.

According to another aspect, the air pump also delivers a diffusing airstream to the diffuser that assists in forming the mixed solution within an inlet portion.

According to another aspect, the receiver includes a Venturi section and the distribution shaft engages the receiver downstream of the Venturi section, and wherein the effluent pathway, the internal air pathway, and the fluid outlet are separated from one another within the distribution shaft.

According to another aspect, the processing cap includes a plurality of air channels that extend from the internal air pathway of the distribution shaft to a plurality of drying channels through which the coagulated particles move.

According to another aspect, the plurality of air channels include branch channels that direct the delivery airstream into two adjacent drying channels of the plurality of drying channels.

According to yet another aspect of the present disclosure, a particulate filtration system for an appliance includes: a receiver having a Venturi section that receives and combines a effluent with a coagulant from a coagulant reservoir to define a mixed solution; a distribution shaft that receives the mixed solution from the Venturi section, the distribution shaft having an effluent pathway, an internal air pathway, and a fluid outlet; a rotor that rotates about a rotational axis to produce a centrifugal force, wherein the rotor includes a separating chamber that receives the mixed solution from the effluent pathway, and wherein the rotor separates the mixed solution, using the centrifugal force, into a filtered fluid and coagulated particles, the coagulated particles being biased by the centrifugal force upward along an angled perimeter wall of the separating chamber, and wherein the filtered fluid is directed into the fluid outlet of the distribution shaft; processing cap that receives the coagulated particles from the angled perimeter wall and delivers the coagulated particles from the rotor and to an upper surface of the processing cap; and an air pump that delivers a delivery airstream through the internal air pathway of the distribution shaft and into the processing cap, wherein the delivery airstream at least partially moves the coagulated particles through drying channels of the processing cap and to the upper surface, the drying channels extending inward from proximate the angled perimeter wall to proximate the distribution shaft, and wherein the centrifugal force biases the coagulated particles from the upper surface of the processing cap to a collection basin that surrounds the rotor.

According to another aspect, the air pump also delivers a diffusing airstream to the receiver, wherein the diffusing airstream assists in forming the mixed solution.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A particulate filtration system for an appliance, the particulate filtration system comprising:
a receiver having an inlet portion and an outlet portion, wherein the inlet portion is configured to receive effluent from a wastewater conduit, and wherein the inlet portion at least partially combines the effluent and a coagulant from a coagulant reservoir to define a mixed solution;
a rotor that receives the mixed solution from the receiver and rotates about a rotational axis to generate a centrifugal force to separate the mixed solution into coagulated particles and filtered fluid, wherein the centrifugal force biases the coagulated particles from an interior of the rotor and upward along an angled perimeter wall of the rotor, and wherein the filtered fluid is delivered to a drain outlet via the outlet portion of the receiver; and
a collection basin that surrounds the rotor, wherein the rotor rotates within a central area of the collection basin, and wherein the collection basin receives the coagulated particles from the angled perimeter wall of the rotor.

2. The particulate filtration system of claim 1, wherein the inlet portion includes a Venturi section that diffuses the effluent and the coagulant to define the mixed solution.

3. The particulate filtration system of claim 2, wherein the outlet portion of the receiver includes a distribution shaft that delivers the mixed solution from the inlet portion to the interior of the rotor.

4. The particulate filtration system of claim 3, further comprising an air pump that delivers a diffusing airstream into the inlet portion of the receiver that assists in forming the mixed solution.

5. The particulate filtration system of claim 4, wherein the rotor includes a processing cap that delivers the coagulated particles from the angled perimeter wall and through a plurality of drying channels that extend inward toward the receiver, wherein the coagulated particles are moved through the plurality of drying channels using a delivery airstream, wherein the air pump provides the delivery airstream.

6. The particulate filtration system of claim 5, wherein the delivery airstream delivers the coagulated particles to an upper surface of the processing cap.

7. The particulate filtration system of claim 6, wherein the delivery airstream is delivered into the processing cap through an internal air pathway of the distribution shaft.

8. The particulate filtration system of claim 3, wherein the filtered fluid is delivered to the drain outlet via a fluid outlet of the distribution shaft.

9. The particulate filtration system of claim 6, wherein the plurality of drying channels extend from the angled perimeter wall to a plurality of respective ports that deliver the coagulated particles to the upper surface of the processing cap, wherein the centrifugal force biases the coagulated particles from the upper surface of the processing cap and into the collection basin.

10. The particulate filtration system of claim 1, further comprising a plurality of electromagnetic poles, wherein the electromagnetic poles selectively cooperate with magnets of the rotor to produce an electromotive force that rotates the rotor about the rotational axis.

11. The particulate filtration system of claim 1, wherein the collection basin is separable from the rotor for disposal of the coagulated particles within the collection basin.

12. The particulate filtration system of claim 5, wherein the distribution shaft includes a separation member that divides the interior of the rotor between an upper portion and a lower portion, wherein the filtered fluid accumulates within the lower portion and wherein foam that is generated during the operation of the rotor at least partially accumulates within the upper portion above the separation member.

13. The particulate filtration system of claim 12, wherein the processing cap includes at least one vent proximate the distribution shaft, wherein the vents are in communication with the upper portion of the rotor and with an upper surface of the processing cap, wherein in response to the foam accumulating within the upper portion, at least a portion of the foam is delivered through the at least one vent and to the upper surface of the processing cap.

14. A particulate filtration system for an appliance pedestal, the particulate filtration system comprising:
a receiver that receives effluent, wherein the receiver includes a diffuser that combines a coagulant with the effluent to at least partially define a mixed solution;
a distribution shaft that receives the mixed solution from the receiver, the distribution shaft having an internal air pathway and a fluid outlet;
a rotor that rotates about a rotational axis to produce a centrifugal force, wherein the rotor receives the mixed solution from an effluent pathway of the distribution shaft, the rotor including a separating chamber that separates the mixed solution using the centrifugal force into a filtered fluid and coagulated particles, wherein the filtered fluid is delivered away from the rotor via the fluid outlet;
a processing cap that receives the coagulated particles from an angled perimeter wall of the rotor and delivers the coagulated particles from the rotor and to an upper surface of the processing cap; and
an air pump that delivers a delivery airstream through the internal air pathway of the distribution shaft and into the processing cap, wherein the delivery airstream at least partially moves the coagulated particles through drying channels of the processing cap and to the upper surface, and wherein the centrifugal force biases the coagulated particles from the upper surface of the processing cap to a collection basin that surrounds the rotor.

15. The particulate filtration system of claim 14, wherein the air pump also delivers a diffusing airstream to the diffuser that assists in forming the mixed solution within an inlet portion.

16. The particulate filtration system of claim 14, wherein the receiver includes a Venturi section and the distribution shaft engages the receiver downstream of the Venturi section, and wherein the effluent pathway, the internal air pathway, and the fluid outlet are separated from one another within the distribution shaft.

17. The particulate filtration system of claim 14, wherein the processing cap includes a plurality of air channels that extend from the internal air pathway of the distribution shaft to a plurality of drying channels through which the coagulated particles move.

18. The particulate filtration system of claim 17, wherein the plurality of air channels include branch channels that direct the delivery airstream into two adjacent drying channels of the plurality of drying channels.

19. A particulate filtration system for an appliance, the particulate filtration system comprising:
a receiver having a Venturi section that receives and combines a effluent with a coagulant from a coagulant reservoir to define a mixed solution;
a distribution shaft that receives the mixed solution from the Venturi section, the distribution shaft having an effluent pathway, an internal air pathway, and a fluid outlet;
a rotor that rotates about a rotational axis to produce a centrifugal force, wherein the rotor includes a separating chamber that receives the mixed solution from the effluent pathway, and wherein the rotor separates the mixed solution, using the centrifugal force, into a filtered fluid and coagulated particles, the coagulated particles being biased by the centrifugal force upward along an angled perimeter wall of the separating chamber, and wherein the filtered fluid is directed into the fluid outlet of the distribution shaft;
a processing cap that receives the coagulated particles from the angled perimeter wall and delivers the coagulated particles from the rotor and to an upper surface of the processing cap; and
an air pump that delivers a delivery airstream through the internal air pathway of the distribution shaft and into the processing cap, wherein the delivery airstream at least partially moves the coagulated particles through drying channels of the processing cap and to the upper surface, the drying channels extending inward from proximate the angled perimeter wall to proximate the distribution shaft, and wherein the centrifugal force biases the coagulated particles from the upper surface of the processing cap to a collection basin that surrounds the rotor.

20. The particulate filtration system of claim 19, wherein the air pump also delivers a diffusing airstream to the receiver, wherein the diffusing airstream assists in forming the mixed solution.
